(19) United States
(12) Patent Application Publication
(10) Pub. No.: US 2017/0092122 A1
(43) Pub. Date: Mar. 30, 2017

(54) Vehicle Telematics Policing System

(71) Applicant: MASTERCARD INTERNATIONAL INCORPORATED, Purchase, NY (US)

(72) Inventor: Ashutosh Sharan, Gurgaon (IN)

(21) Appl. No.: 15/277,593

(22) Filed: Sep. 27, 2016

(30) Foreign Application Priority Data
Sep. 28, 2015 (SG) 10201508064T

(51) Int. Cl. G08G 1/052; G07C 5/00; G06F 17/30; G08G 1/017

(52) U.S. Cl. CPC G08G 1/052; G08G 1/017; G07C 5/008; G06F 17/30539

(57) ABSTRACT

A vehicle telematics system for policing general road users and vehicles comprising a detector coupled to a telematics server and a central policing system is disclosed. Telematics information relating to a vehicle will be used to determine if the vehicle is outside predefined safe driving parameter ranges. When the vehicle is determined to be operating outside predefined safe driving parameter ranges, this vehicle operation, together with the identifying information and location information of the vehicle, will be sent to the central policing system, which in turn, will be broadcasted to police vehicles located near the vehicle concerned.

### FIELD

The present disclosure generally relates to vehicle telematics systems, and more particularly relates to a telematics policing system for use with general purpose policing and monitoring system for vehicles.

### BACKGROUND

This section provides background information related to the present disclosure which is not necessarily prior art.

Telematics refers to the integration and utilization of telecommunications and informatics technologies to send, receive and store information relating to remote objects via wireless communication or internet means. Vehicle telematics systems combine vehicle control and monitoring, location tracking and wireless communications capabilities, and were pioneered by General Motors, Ford and the American Automobile Association in the 1990s. In general, vehicle telematics systems provide services such as roadside assistance, emergency services, airbag deployment notification, accident assist, remote door locking/unlocking, and stolen vehicle tracking. Newer systems also provide services such as accessing the internet and e-mails and infotainment.

It is known that road accidents, driving misbehavior and motor vehicle theft are commonplace everywhere. Thus, road safety is of paramount importance, and the goal is to reduce or mitigate road accidents and incidents. An established telematics system (e.g., General Motors' OnStar system) has been implemented to vehicles for tracking stolen or carjacked vehicles and subsequently providing the police with the exact location, speed and direction of movement of the vehicles. In later models, this telematics system slows down or even shuts off the vehicles from moving. However, these telematics systems are primarily targeted at stolen or carjacked vehicles only.

A relatively new type of vehicle telematics system for policing has been developed to monitor police vehicles for police officer safety. Such system monitors the location and operating conditions of police vehicles. The telematics information is sent to law enforcement agencies for monitoring the driving behavior of police officers. However, this system is only applicable to monitoring the driving behavior of police officers.

Thus, what is needed is a system and method for alerting police of general vehicle operation outside safe driving parameter range by monitoring vehicle telematics information. Furthermore, other desirable features and characteristics will become apparent from the subsequent detailed description and the appended claims, taken in conjunction with the accompanying drawings and this background of the disclosure.

### SUMMARY

This section provides a general summary of the disclosure, and is not a comprehensive disclosure of its full scope or all of its features. Aspects and embodiments of the disclosure are also set out in the accompanying claims.

In accordance with an aspect of the present disclosure, a system for policing through vehicle telematics is provided. The system includes a detector which is configured to receive vehicle telematics information from a telematics server, detect when the vehicle telematics information corresponding to a vehicle is outside predefined safe driving parameters, and, responsive to the detection, transmit identifying information of the vehicle and the corresponding vehicle telematics information to a central policing system.

In accordance with a further aspect, a method for policing using vehicle telematics information is provided. The method includes accessing vehicle telematics information from a telematics server and detecting when the vehicle telematics information corresponding to a vehicle is outside predefined safe driving parameters. The method further includes, responsive to the detection, sending identifying information of the vehicle and the corresponding vehicle telematics information to a central policing system.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. In addition, the accompanying drawings, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1, comprising FIGS. 1A to 1D, depicts block diagrams of a system for vehicle telematics policing in accordance with a present embodiment, wherein FIG. 1A depicts the system for telematics policing including a vehicle telematics server and a driving outside defined parameters detector in accordance with the present embodiment and FIGS. 1B to 1D depict alternate arrangements of the vehicle telematics server and the detector in accordance with various alternate embodiments.

FIG. 2 depicts a block diagram of a vehicle for operation within the system for vehicle telematics policing of FIG. 1 in accordance with the present embodiment.

FIG. 3 depicts a flowchart of the operation of the system for vehicle telematics policing of FIG. 1 in accordance with the present embodiment.

FIG. 4 depicts a block diagram of the driving outside defined parameters detector of FIG. 1 in accordance with the present embodiment.

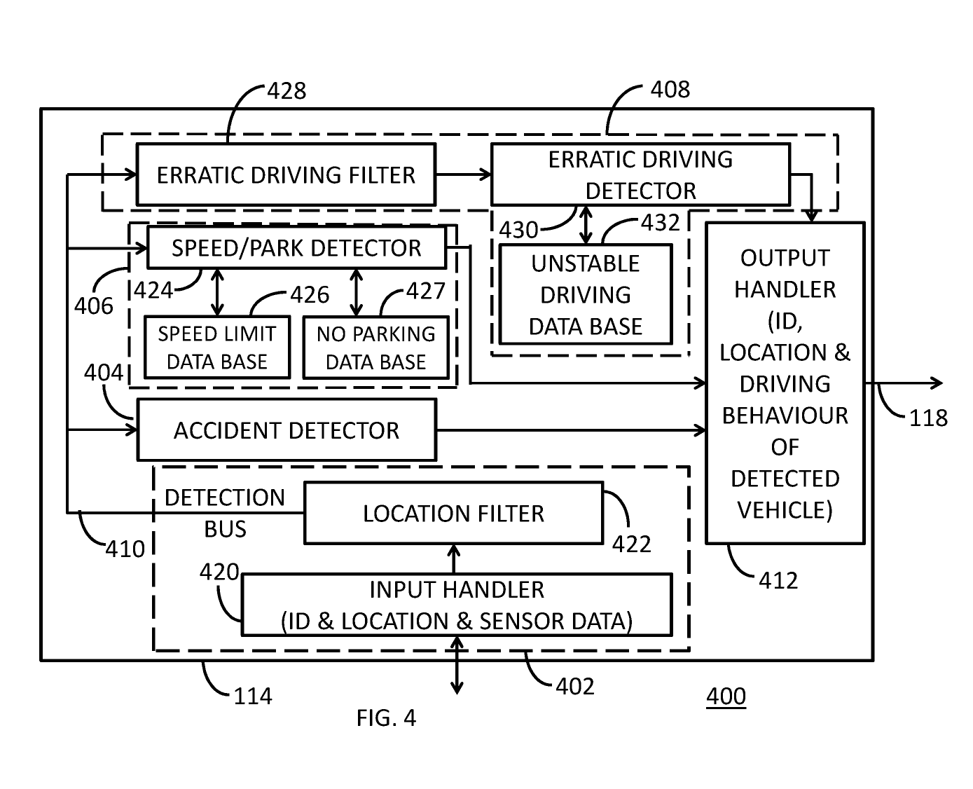

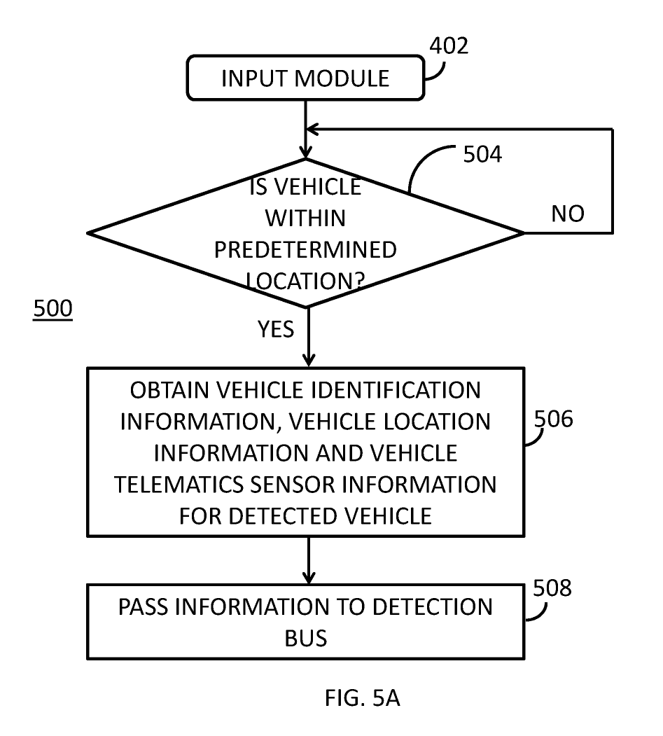

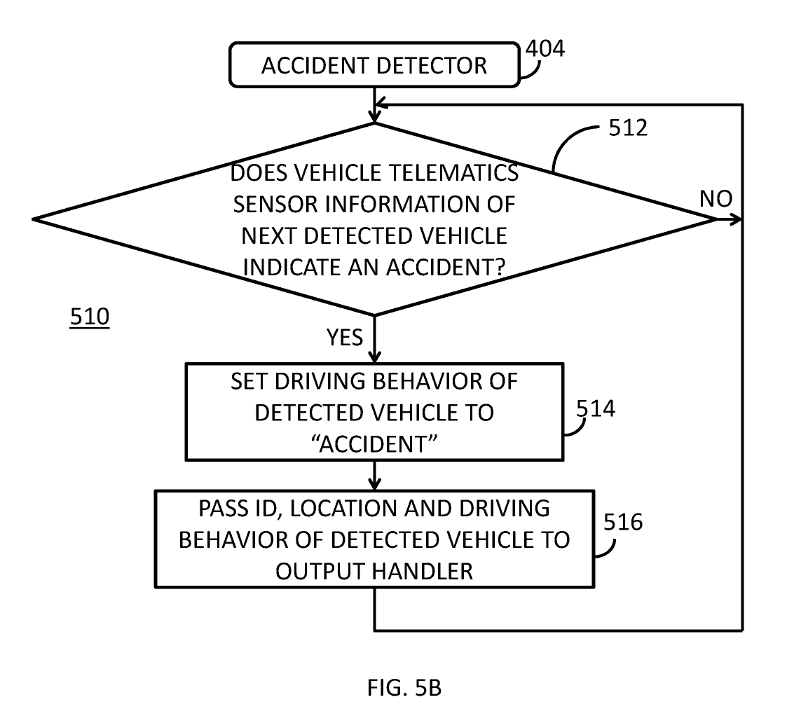

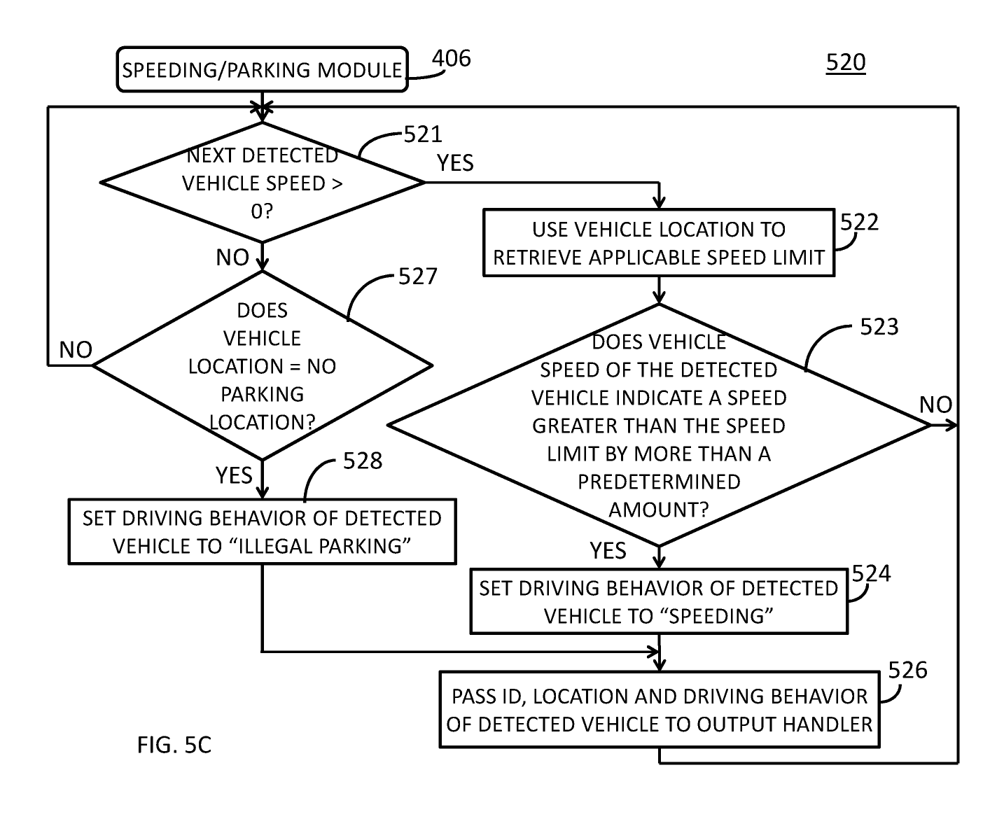

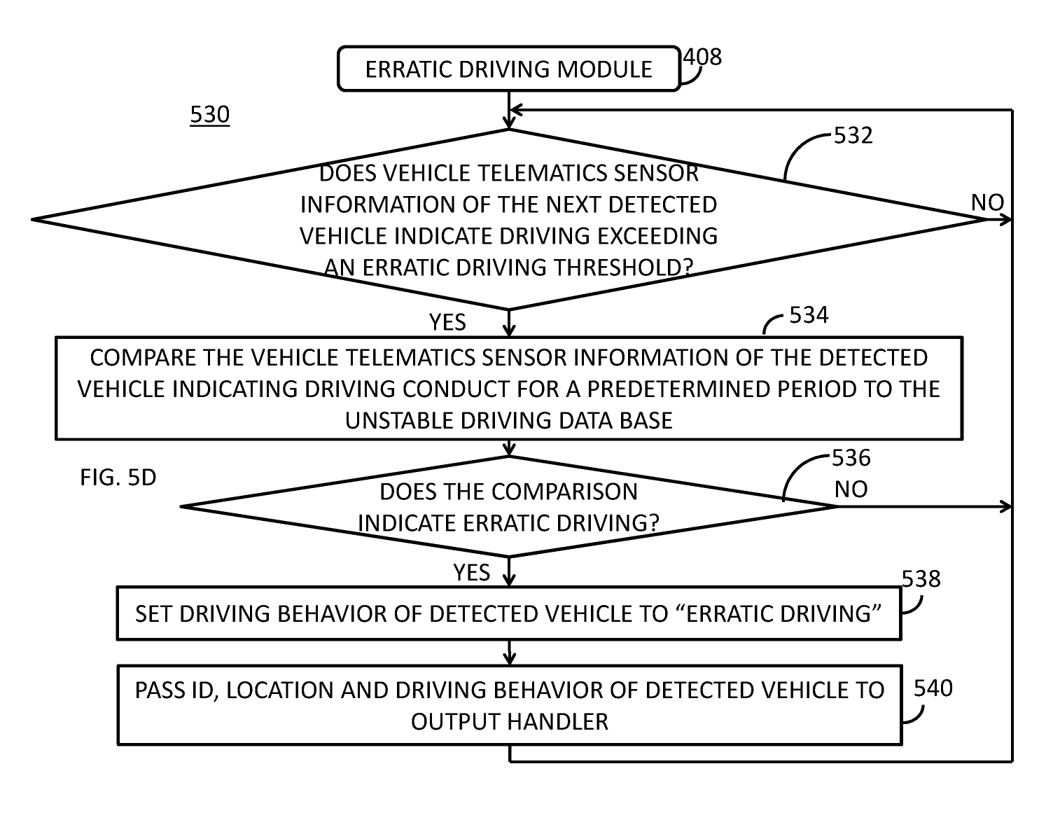

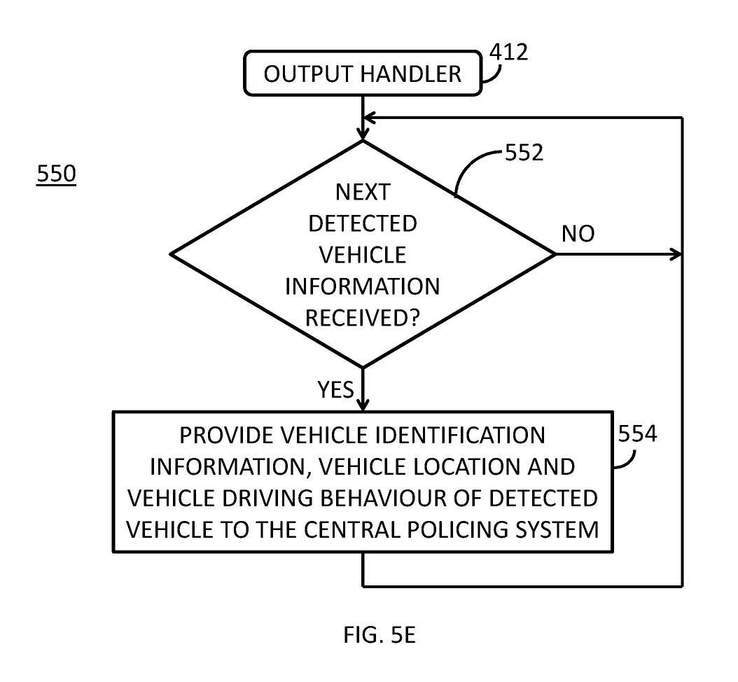

And FIG. 5, comprising FIGS. 5A to 5E, depicts operations of the various components of the driving outside defined parameters detector of FIG. 4 in accordance with the present embodiment.

Skilled artisans will appreciate that elements in the figures are illustrated for simplicity and clarity and have not necessarily been depicted to scale. For example, the dimensions of some of the elements in the block diagrams or flowcharts may be exaggerated in respect to other elements to help to improve understanding of the present embodiments.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description. It is the intent of the present embodiment to present a general purpose system for policing through vehicle telematics for ordinary road users and vehicles that can address the problems related to driving within and outside defined parameters. While the discussion herein focuses on defined parameters concerning speed, erratic driving and accidents, those skilled in the art will realize that other driving parameters could be monitored in accordance with the present embodiment.

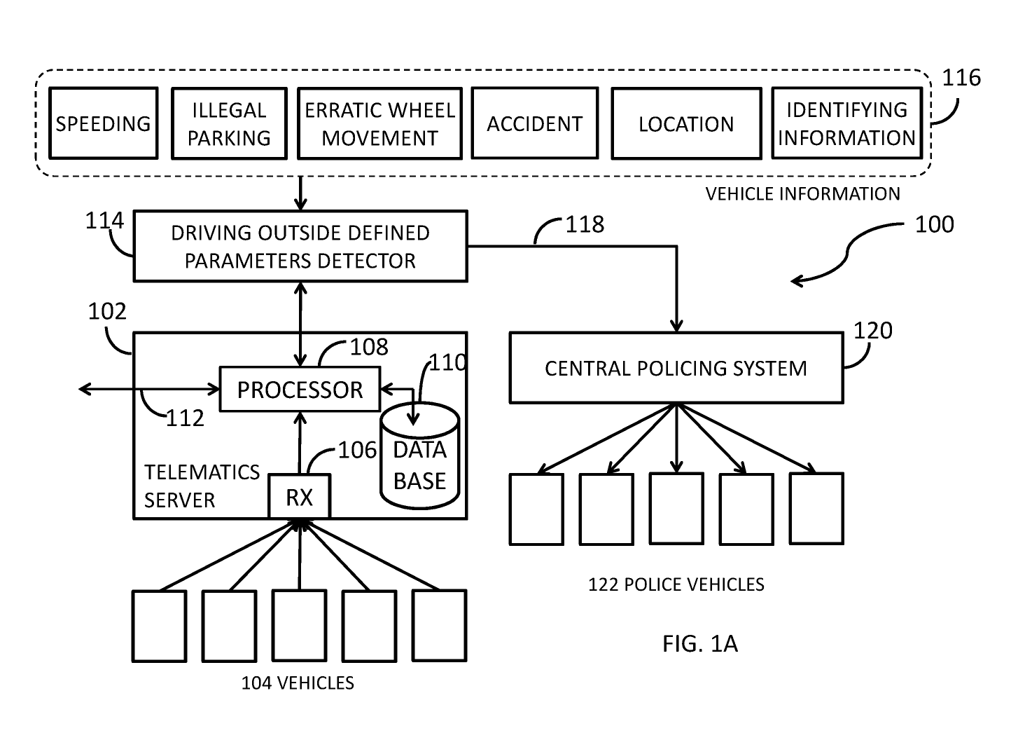

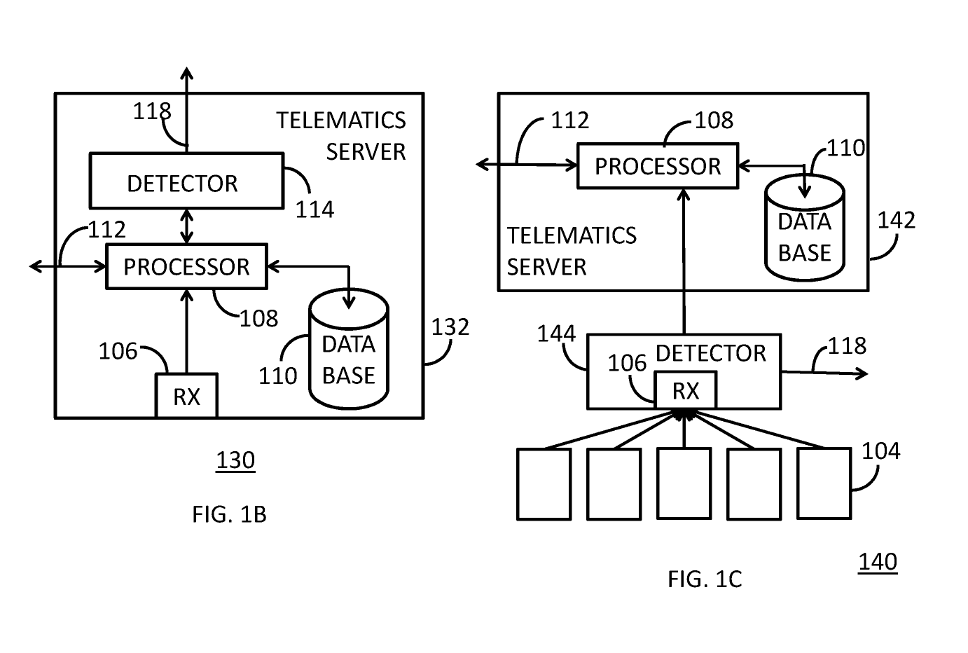

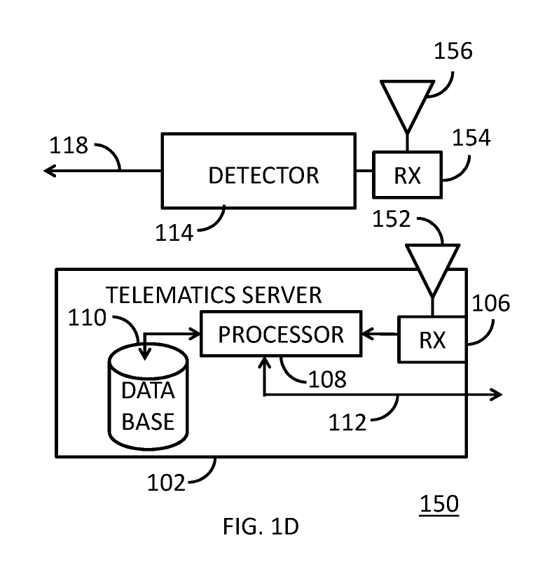

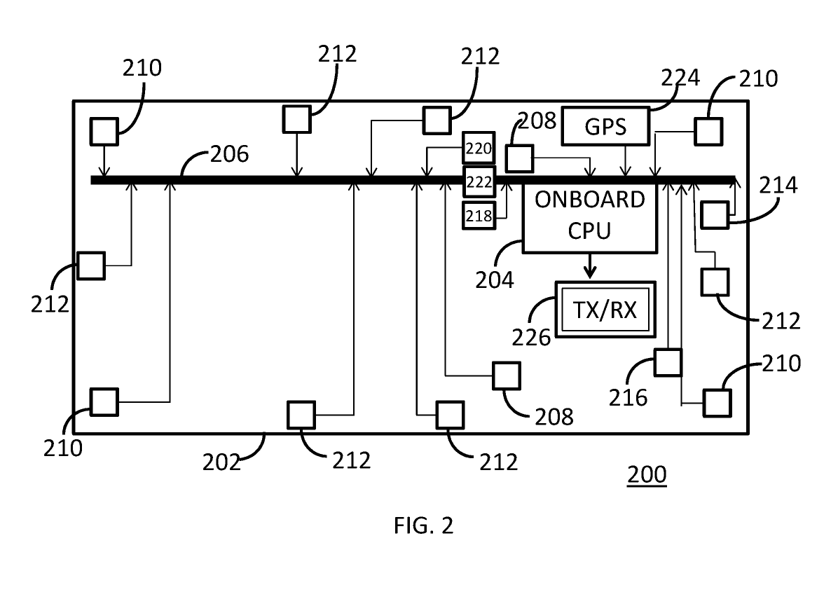

Referring to FIG. 1A, a block diagram of a vehicle telematics policing system 100 for policing through vehicle telematics in accordance with a present embodiment is depicted. The system 100 includes a telematics server 102 receiving telematics information from vehicles 104. Telematics systems such as the system 100 receive information from various sensors within the vehicles 104 across radio frequency (RF) systems such as cellular systems (e.g., CDMA cellular system) for monitoring of the operation of the vehicles 104, as seen in more detail in FIG. 2 as discussed herein below. The telematics server 102 receives information from the vehicles 104 via a receiver 106 which demodulates and decodes the RF signals and forwards those signals to a processor 108. As the main purpose of a telematics server, such as the server 102, is monitoring of vehicle operation, the information is stored into a data base 110. A connection 112 to the processor 108 allows retrieval of vehicle telematics information which can, for example, be used by vehicle manufacturers to determine operational characteristics of various vehicle models or operational characteristics in various environmental regions (e.g., high altitude regions, desert regions, tropical regions, etc.).

The information is forwarded from the vehicles 104 to the server 102 in two typical modes. A first mode is a periodic mode including periodical transmission of operational information. In this mode, the vehicles 104 send information collected over a predetermined time period at regular intervals to the server 102. The second mode is an event-triggered mode. Event-triggered transmissions, as will be discussed in more detail in the description of FIG. 2, occur when a particular sensor activity is detected (e.g., air bag activation sensor activity or crash detection sensor activity).

In accordance with the present embodiment, a detector 114 is coupled to the telematics server 102 for accessing vehicle telematics information via the processor 108 and detecting in near real-time when the vehicle telematics information corresponding to one or more of the vehicles 104 is outside predefined safe driving parameters. Operation of the detector 114 is described in more detail in the block diagram of FIG. 4 and the flowcharts of FIG. 5.

The detector 114 can data mine the data in the data base 110 or receive a portion or all of the feed of telematics data being received by the processor 108. In accordance with FIG. 1A, the detector 114 is coupled to the telematics server 102 and can be, for example, operated separately from the telematics server 102. In this arrangement, the detector 114 can data mine the data base 110 via the processor 108 for retrieval of near real-time vehicle telematics data. Alternatively, the detector 114 in FIG. 1A can be coupled to the processor 108 to have the vehicle telematics information received and processed by the processor 108 forwarded to the detector 114 coincident with the processor 108 forwarding the processed vehicle telematics information to the data base 110.

The detector 114 determines whether the vehicle telematics information received is outside certain predefined operation parameters as described in more detail herein below. If the detector 114 detects vehicle information outside the predefined operation parameters, the detector 114 sends information 116 including vehicle identifying information, vehicle location information and information derived from the vehicle telematics information identifying the vehicle operation outside the predefined operation parameters (e.g., speeding, illegal parking, erratic driving, accident) along a transmission path 118 (which could be wired (e.g., wired to an internet connection) or wireless (e.g., a cellular connection or devoted RF connection)) to a central policing system 120. The policing system 120 then forwards this information to police vehicles 122 which the policing system 120 determines are near the vehicle location forwarded by the detector 114 in the information 116.

Referring to FIG. 1B, a block diagram 130 depicts a first alternate arrangement of the telematics server and the detector 114. In this first alternate arrangement, the detector 114 is part of a telematics server 132 and the transmission path 118 couples the detector 114 in the telematics server 132 to the policing system 120 (FIG. 1A). In the arrangement of FIG. 1B, the operator of the vehicle telematics server 132 is also the operator of the detector 114 (as opposed to FIG. 1A, where the operator of the detector 114 could be different than the operator of the telematics server 102). A second alternate arrangement depicted in a block diagram 140 of FIG. 1C also depicts an alternate arrangement where the operator of a vehicle telematics server 142 is necessarily also the operator of a detector 144. The detector 144 receives the telematics signals from the vehicles 104 and processes them for detection of operation outside the predefined parameters and also passes the signal on to the processor 108 of the telematics server 142. The detector 144 would include the RF receiver 106 for receiving, demodulating and decoding the vehicle telematics information from the vehicles 104.

Referring to FIG. 1D, a third alternate arrangement is depicted in a block diagram 150. While not shown in the previous figures, those skilled in the art of RF communications will understand that the vehicles 104 communicate via a RF system. This RF system is preferably a cellular system which could facilitate communication with the telematics server 102 via cellular communication. In this manner, the cellular system would send RF cellular signals to an antenna 152 connected to the receiver 106. In accordance with this third alternate arrangement, the detector 114 is coupled to a receiver 154 connected to an antenna 156 for receiving the same cellular transmissions and demodulating and decoding them. Thus, the detector 114 receives the same vehicle telematics information without a direct connection with the telematics server 102.

Those skilled in the art will realize that a vehicle telematics policing system in accordance with any of the arrangements of FIGS. 1A to 1D can be expanded to comprise a plurality of detectors 114, with each detector 114 reviewing vehicle telematics data received from vehicles within a predetermined area, for example. In connection with this arrangement, for example, each detector 114 could be assigned to a separate policing system 120. Other arrangements for accomplishing vehicle telematics policing in accordance with the present embodiments will be apparent to those skilled in the art from the discussion herein.

In the prior art, police vehicles were monitored for the safety of police officers, or only stolen or carjacked vehicles were reported to the police. In accordance with the present embodiment, a general purpose vehicle telematics policing system is provided for monitoring and policing ordinary road users. The present system advantageously improves and enhances road safety, because the majority of road accidents are caused by ordinary road users.

Referring to FIG. 2, a block diagram 200 depicts a vehicle 202 which is an exemplary one of the vehicles 104 providing vehicle telematics information to the vehicle telematics server 102. The vehicle 202 includes an onboard central processing unit (CPU) 204 which receives signals from a plurality of sensors coupled to a sensor bus 206. The sensors include, for example, air bag activation sensors 208; wheel sensors 210 for sensing rotational issues of any of the four tires; front, back and side crash sensing accelerometers 212 (which may be used to trigger air bag activation); a radiator fluid thermal sensor 214; a battery voltage sensor 216; an accelerator sensor 218; a brake sensor 220 and a steering sensor 222. Those skilled in the art will understand that the relative location and function of the sensors in FIG. 2 is shown to provide an example of possible sensors and their possible locations; locations could differ and there could be more or less sensors.

A geolocation receiver 224, such as a Global Positioning System (GPS) receiver, also provides location signals to the CPU 204 for use by a navigation system of the vehicle 202 and for vehicle telematics information in accordance with the present embodiment. Also, a transceiver 226 is provided to send vehicle telematics information from the vehicle 202 to the telematics server 102 in accordance with the present embodiment. Preferably the transceiver 226 is a cellular transceiver so that the signals can be encoded and modulated for transmission across cellular networks to the telematics server 102. While the primary function of the transceiver 226 is transmission of information, it could also be used to receive information, such as signals to open locked doors if the owner has locked their keys in the car.

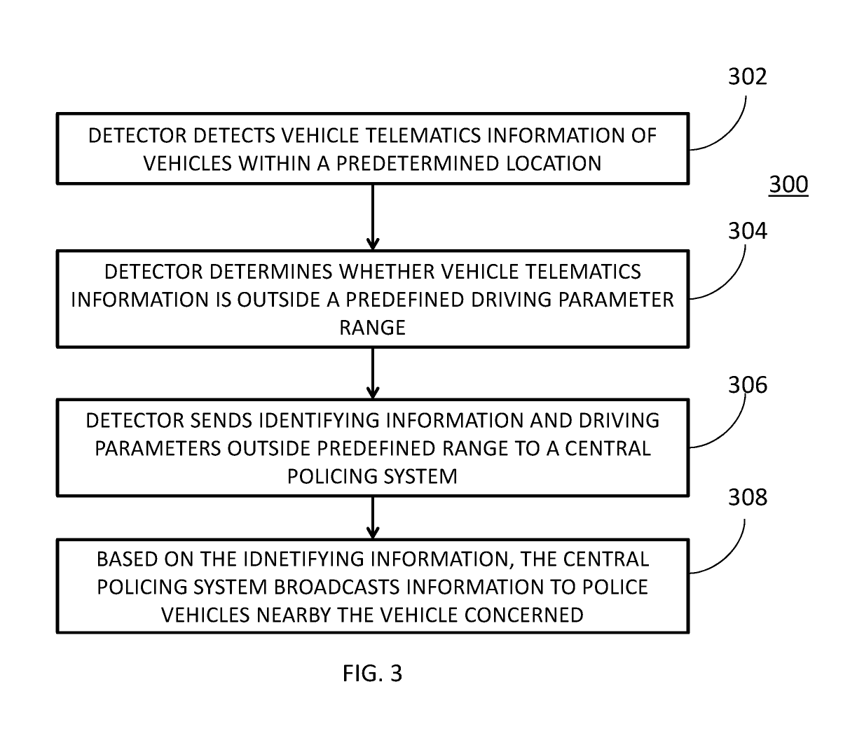

Referring to FIG. 3, operation of the telematics policing system 100 is depicted in flowchart 300. The detector 114 detects 302 driving parameters of a vehicle 104, 202 by either continuously or at regular time intervals reviewing vehicle telematics information received by the telematics server 102. The detector 114 determines 304 whether the driving parameters of the vehicle 104, 202 are outside predefined safe driving parameter ranges. When the detector 114 determines 304 that the driving parameters are outside the predefined driving parameter ranges, the detector 114 sends 306 both the identifying information of the vehicle (including location information) and the corresponding vehicle telematics information outside the predefined safe driving parameter ranges to the central policing system 120. Subsequently, the central policing system 120 broadcasts 308 the identifying information of the vehicle 104, 202 and the corresponding vehicle telematics information to police vehicles 122 near the present location of an identified vehicle driving outside predefined driving parameter ranges (e.g., within a distance from the vehicle location corresponding to a maximum desired estimated response time). The central policing system 120 may also broadcast to the police vehicles 122 a brief descriptor of the detected driving behavior (e.g. “exceeding speed limit”, “parking in a No Parking zone” “exceeding safe cornering speed”, “erratic driving”).

Vehicle telematics information 116 outside the predefined safe driving parameter ranges that the detector 114 detects includes one or more of a vehicle moving at speeds indicative of speeding, erratic wheel movements (which may be indicative of driving under the influence of drugs or alcohol, or drowsiness of the driver, for example), and information indicating occurrence of an accident, such as information obtained by the vehicle CPU 204 from the crash sensors 212 and forwarded as vehicle telematics information to the telematics server 102. In addition, the vehicle information 116 includes identifying information of the vehicle (e.g., the unique identifying information of the transceiver 226) and present location information of the vehicle 202 which can be used to uniquely and unambiguously identify the vehicle concerned.

Referring to FIG. 4, a block diagram 400 depicts the detector 114. The detector 114 includes an input module 402 coupled to an input of an accident detector 404, an input of a speeding/parking module 406 and an input of an erratic driving module 408 by a detection bus 410. The outputs of the accident detector 404, the speeding/parking module 406 and the erratic driving module 408 are coupled to an output handler 412.

The input module 402 includes an input handler 420 and a location filter 422. As the detector 114 is coupled to the central policing system 120 having geographical jurisdictional boundaries, the location filter 422 only passes vehicle telematics information to the detection bus 410 that is within the geographical jurisdictional boundaries the central policing system 120. Thus the input handler 420 may be coupled to the telematics server 102 through a wireless or wired communications interface, such that it can transmit data to and/or receive data from the telematics server 102. The communications interface may connect the input handler 420 to a local area network or a wide area network, such as the internet, such that the vehicle telematics information 116 received by the telematics server 102 from vehicles 104 may be retrieved by the input handler 420. The telematics server 102 may be either a data server or a cloud server, and in both cases, the telematics information is accessible by the input handler 420 of the detector 114 in near real-time. FIG. 5A shows a flowchart 500 of an exemplary operation of the input module 402. The input handler 420 obtains at 506 the vehicle identification information, the vehicle location information and the vehicle telematics sensor information for a detected vehicle. The location filter 422 determines at 504 whether the vehicle is within a predetermined location (i.e., within the geographical jurisdictional boundaries the central policing system 120). If the vehicle is within the predetermined location 504, the location filter 422 passes at 508 the information to the detection bus 410 and processing returns to obtain the next telematics information at 506. If the vehicle is not within the predetermined location 504, processing returns directly to obtain the next telematics information at 506.

Exemplary operation of the accident detector 404 operation is shown in flowchart 510 of FIG. 5B. When vehicle telematics information of a next detected vehicle is detected on the detection bus 410, the accident detector 404 determines whether that vehicle telematics sensor information indicates an accident 512. As discussed, this could be sensor information from the airbag sensors 208 indicating activation and/or sensor information from the front, back or side crash sensors 212. If no accident is indicated 512 by the vehicle telematics information, processing continues to the next detected vehicle telematics information. When an accident is indicated 512, the driving behavior of the detected vehicle is set 514 to “ACCIDENT” and the vehicle identification, vehicle location and driving behavior of the vehicle is passed 516 to the output handler 412. Processing then returns to examine 512 the next detected vehicle telematics information.

The speeding/parking module 406 includes a speed/park detector 424, a speed limit data base 426 and a no parking data base 427. An exemplary operation of the speeding module 406 is depicted in flowchart 520 of FIG. 5C. The speed/park detector 424 is coupled to the detection bus 410 to receive vehicle telematics information including vehicle location. The speed/park detector 424 first uses the vehicle speed information to determine 521 whether the speed is greater than zero. If the speed of the vehicle is greater than zero 521, the speed/park detector 424 uses the vehicle location information to retrieve 522 an applicable speed limit for the location indicated by the vehicle location information from the speed limit data base 426. Then processing determines whether the vehicle telematics sensor information (e.g., the wheel sensor(s) 210 information) indicates 523 that the vehicle is speeding. Speeding is defined as a speed greater than the speed limit for the location by greater than a predetermined amount, where the predetermined amount is defined by the central policing system 120. The predetermined amount could be zero or could be five kilometers per hour or some other number to indicate how much over the speed limit the central policing system 120 defines “speeding”. Also, it may be different for different areas and the predetermined amount would be stored in the speed limit data base along with the speed limit: for example, in school zones it may be zero, while on expressways it may be five or ten kilometers per hour.

Speeding may also be defined by reference to exceeding the retrieved speed limit by a predetermined amount for a predetermined duration, e.g. for 1 second, 2 seconds, 5 seconds, 10 seconds, etc. In some instances it may be acceptable for a driver to temporarily exceed the speed limit, for example, when overtaking another vehicle on an expressway or other multi-lane carriageway. As such, the speed/park detector 424 may take into account driving context or location when determining whether the vehicle is speeding or not and speeding over a particular time may be measured by switching the telematics transmission mode to continuous as described hereinafter in accordance with the erratic driving module 408.

If the vehicle is determined 523 to not be speeding, processing returns to determine 521 a vehicle speed for the next vehicle. When the vehicle is determined 523 to be speeding (i.e., exceeding a safe speed), the driving behavior of the detected vehicle is set 524 to “SPEEDING” and the vehicle identification, vehicle location and driving behavior of the vehicle is passed 526 to the output handler 412. Processing then returns to determine 521 a vehicle speed for the next vehicle.

When the speed is determined 521 to not be greater than zero, it is assumed that the vehicle is parked. The speed/park detector 424 then uses the vehicle location information to determine 527 whether the location indicated by the vehicle location information is a NO PARKING zone (i.e., a No Parking location) by comparing the vehicle location information to NO PARKING zones identified in the no parking data base 427. If the vehicle is determined 527 to not be parked in a NO PARKING zone, processing returns to determine 521 a vehicle speed for the next vehicle. When the vehicle is determined 527 to be parked in a NO PARKING zone, the driving behavior of the detected vehicle is set 528 to “ILLEGAL PARKING” and the vehicle identification, vehicle location and driving behavior of the vehicle is passed 526 to the output handler 412. Processing then returns to determine 521 a vehicle speed for the next vehicle.

The erratic driving module 408 includes an erratic driving filter 428, an erratic driving detector 430 and an unstable driving data base 426. An exemplary operation of the erratic driving module 408 is depicted in flowchart 530 of FIG. 5D. The erratic driving filter 428 is coupled to the detection bus 410 to receive vehicle telematics information including vehicle sensor information. A small number of sensed vehicle driving conduct are defined in the erratic driving filter 428 to be thresholds of possible erratic driving. For example, a jerky steering wheel turn of ninety degrees or more sensed by the steering wheel sensor 222 or other erratic wheel movement could be a predefined threshold of possible erratic driving. Also, a quick acceleration following a quick braking (or vice versa) sensed by the accelerator sensor 218 and the brake sensor 220 could be a predefined threshold of possible erratic driving. The erratic driving filter 428 determines 532 whether the vehicle telematics information indicates that a predefined erratic driving threshold has been exceeded. If the erratic driving threshold has not been exceeded 532 processing looks at the next vehicle's telematics information on the detection bus 410. When the erratic driving threshold is exceeded 532, vehicle telematics sensor information indicating driving conduct for a predefined period (e.g., one minute, five minutes) is compared 534 by the erratic driving detector 430 to driving conduct information in the unstable driving data base 432.

As described above, the onboard central processing unit (CPU) 204 of the vehicle 202 telematics system has two typical transmission modes: periodic and event-driven. In accordance with the present embodiment, the erratic driving module 408 requires continuous transmissions for the predefined period in order for the erratic driving detector 430 to compare 534 the telematics sensor information indicating driving conduct to driving conduct information in the unstable driving data base 432. Thus, the onboard central processing unit (CPU) 204 will also have an erratic driving filter which mirrors the operation of the erratic driving filter 428. When the erratic driving filter of the onboard central processing unit (CPU) 204 determines whether the vehicle telematics information indicates that the predefined erratic driving threshold has been exceeded (in the same manner as the determination 532), the onboard central processing unit (CPU) 204 will switch the transmission mode to a continuous transmission mode for the predefined period such that telematics sensor information will be transmitted continuously for the predefined period (e.g., one minute, five minutes).

The unstable driving data base 432 includes a number of sensor readings for the predefined period for erratic or unstable driving, including sensor data for driving under the influence of drugs or alcohol or driving while drowsy. The data on the sensor readings in the unstable driving data base 432 could, for example, be collected from “test cars” to run in a “drunk-driver” condition and a “sober-driver” condition on a “test track”. In addition, data may be collected from actual vehicles that have been caught by police for erratic driving and that data may be used to further improve the accuracy. The driving parameters that may be measured include: speed and change of speed, range of radial distance of the vehicle (i.e., a width of road covered by the vehicle), a number of times road direction is different from car direction (e.g., road direction is in ‘north-south’ direction and car is travelling ‘northeast’, then ‘northwest’ (e.g., zig-zag driving)). If the comparison 534 does not indicate erratic driving 536, processing returns to have the erratic driving filter 428 look at the next vehicle's telematics information.

When the comparison 534 indicates erratic driving 536, the driving behavior of the detected vehicle is set 538 to “ERRATIC DRIVING” and the vehicle identification, vehicle location and driving behavior of the vehicle is passed 540 to the output handler 412. Processing then returns for the erratic driving filter 428 to determine 532 whether the vehicle telematics information for the next vehicle exceeds the erratic driving threshold.

Referring to FIG. 5E, a flowchart 550 depicts operation of the output handler 412. When the output handler detects vehicle information being received 552, the output handler provides 554 vehicle identification information, vehicle location information and vehicle driving behavior of the detected vehicle to the central policing system 120.

In this manner, the detector 114 can detect, either continuously or at regular time intervals, vehicle telematics information of the vehicles 104 to determine if such vehicle telematics information corresponds to driving parameters within predefined driving parameter ranges. Thus, when vehicle telematics information 116 is detected to be outside the predefined driving parameter ranges, the detector 114, through wireless communication or internet means, will transmit the vehicle information to a central policing system 120 for broadcast to police vehicles 122 near the location of the vehicles driving outside safe driving parameter ranges. The central policing system 120 may broadcast, to police vehicles 122, a brief descriptor of the detected unsafe driving behavior (e.g. “exceeding speed limit”, “exceeding safe cornering speed”, “erratic driving”).

An advantage of the vehicle telematics policing system in accordance with the present embodiment is that it is capable of operating in real-time or near real-time. This can be accomplished by employing data analytical techniques, such as machine learning or data mining, as both the telematics server 102 and the central policing system 120 contain and handle huge amounts of information. For example, the telematics server 102 can cluster telematics information based on the present geographical location of the vehicle, such as different cities, suburbs and states/provinces, so that the central policing system 120 can broadcast the corresponding vehicle information 116 of those vehicles detected by the detector 114 to be operating outside predefined safe driving parameters to those police vehicles 122 within a predetermined distance from the present location of the vehicle concerned.

Thus, it can be seen that the present embodiment can provide a system and method for alerting police of general vehicle operation outside safe driving parameter ranges by monitoring vehicle telematics information. In this manner, operation in accordance with the present embodiment advantageously improves and enhances road safety. While exemplary embodiments have been presented in the foregoing detailed description, it should be appreciated that a vast number of variations exist.

It should further be appreciated that the exemplary embodiments are only examples, and are not intended to limit the scope, applicability, operation, or configuration of the present disclosure in any way. Rather, the foregoing detailed description will provide those skilled in the art with a convenient road map for implementing an exemplary embodiment of the present disclosure, it being understood that various changes may be made in the function and arrangement of elements and methods of operation described in an exemplary embodiment without departing from the scope of the present disclosure as set forth in the appended claims.

With that said, it should be appreciated that one or more aspects of the present disclosure transform a general-purpose computing device into a special-purpose computing device when configured to perform the functions, methods, and/or processes described herein.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

And again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for policing through vehicle telematics comprising a detector which is configured to:
receive vehicle telematics information from a telematics server;
detect when the vehicle telematics information corresponding to a vehicle is outside predefined safe driving parameters; and
responsive to said detection, transmit identifying information of the vehicle and the corresponding vehicle telematics information to a central policing system.

2. The system in accordance with claim 1, further comprising the telematics server for receiving vehicle telematics information.

3. The system in accordance with claim 1, further comprising the central policing system coupled to the detector for receiving identifying information of the vehicle and the corresponding vehicle telematics information outside the predefined safe driving parameters.

4. The system in accordance with claim 1, wherein the identifying information of the vehicle comprises present location information of the vehicle, and wherein the central policing system broadcasts the identifying information of the vehicle and the corresponding vehicle telematics information to police vehicles within a predetermined distance from the present location information of the vehicle.

5. The system in accordance with claim 1, wherein the corresponding vehicle telematics information comprises information indicating one or more of: vehicle exceeding safe speeds, vehicle parked in a NO PARKING zone, erratic wheel movement, and information indicating occurrence of an accident.

6. The system in accordance with claim 1, wherein the detector includes one or more of an accident detector, a speed/park detector and an erratic driving detector.

7. The system in accordance with claim 6, wherein the detector includes a speeding/parking module, the speeding/parking module comprising the speed/park detector and a speed limit data base coupled to the speed/park detector, the speed limit data base having location-based speed limit information stored therein.

8. The system in accordance with claim 7, wherein the speeding detector compares a present vehicle speed to a speed limit at a location retrieved from the speed limit data base in response to a present vehicle location to determine if the vehicle is exceeding safe speeds.

9. The system in accordance with claim 6, wherein the detector includes a speeding/parking module, the speeding/parking module comprising the speed/park detector and a no parking data base coupled to the speed/park detector, the no parking data base having location-based no parking information stored therein.

10. The system in accordance with claim 9, wherein the speed/park detector compares a present vehicle location to a no parking location retrieved from the no parking data base to determine if the vehicle is illegally parked.

11. The system in accordance with claim 6, wherein the detector includes an erratic driving module, the erratic driving module comprising the erratic driving detector and an erratic driving filter and an unstable driving data base both coupled to the erratic driving detector, the speed limit data base having location-based speed limit information stored therein.

12. The system in accordance with claim 11, wherein the erratic driving filter determines whether present vehicle driving conduct exceeds an erratic driving threshold.

13. The system in accordance with claim 12, wherein the erratic driving detector compares driving conduct for a predefined period to stored driving conduct in the unstable driving data base to determine erratic driving conduct in response to the erratic driving filter determining that the present vehicle driving conduct exceeds an erratic driving threshold.

14. The system in accordance with claim 12, wherein erratic driving conduct comprises erratic wheel movement.

15. A method for policing using vehicle telematics information comprising:
accessing, by a processor, vehicle telematics information from a telematics server;
detecting when the vehicle telematics information corresponding to a vehicle is outside predefined safe driving parameters; and
responsive to said detection, sending identifying information of the vehicle and the corresponding vehicle telematics information to a central policing system.

16. The method in accordance with claim 15, wherein the step of sending the telematics information to the central policing system comprises:
sending present location information of the vehicle to the central policing system; and
the central policing system broadcasting the identifying information of the vehicle and the corresponding vehicle telematics information outside the predefined safe driving parameters to police vehicles within a predetermined distance from the present location information of the vehicle.

17. The method in accordance with claim 15, wherein the corresponding vehicle telematics information comprises information indicating one or more of: vehicle exceeding safe speeds, vehicle parked in a NO PARKING zone, erratic wheel movement, and information indicating occurrence of an accident.
